(19) United States
(12) Patent Application Publication
(10) Pub. No.: US 2018/0137109 A1
(43) Pub. Date: May 17, 2018

(54) METHODOLOGY FOR AUTOMATIC MULTILINGUAL SPEECH RECOGNITION

(71) Applicant: THE CHARLES STARK DRAPER LABORATORY, INC., Cambridge, MA (US)

(72) Inventors: Rami S. Mangoubi, Newton, MA (US); David T. Chappell, Cambridge, MA (US)

(21) Appl. No.: 15/810,980

(22) Filed: Nov. 13, 2017

Related U.S. Application Data
(60) Provisional application No. 62/420,884, filed on Nov. 11, 2016.

(51) Int. Cl. G06F 17/28; G06F 17/27; G10L 15/26; G10L 15/187; G10L 15/14; G10L 15/18; G06F 17/30

(52) U.S. Cl. CPC G06F 17/2872; G06F 17/289; G06F 17/2735; G10L 15/26; G10L 2015/0633; G10L 15/142; G10L 15/1807; G06F 17/30669; G10L 15/187

(57) ABSTRACT

A method and device are provided for multilingual speech recognition. In one example, a speech recognition method includes receiving a multilingual input speech signal, extracting a first phoneme sequence from the multilingual input speech signal, determining a first language likelihood score indicating a likelihood that the first phoneme sequence is identified in a first language dictionary, determining a second language likelihood score indicating a likelihood that the first phoneme sequence is identified in a second language dictionary, generating a query result responsive to the first and second language likelihood scores, and outputting the query result.

### CROSS-REFERENCE TO RELATED APPLICATIONS

This application claims the benefit of priority under 35 U.S.C. § 119(e) to co-pending U.S. Provisional Application No. 62/420,884, filed on Nov. 11, 2016, which is incorporated herein by reference in its entirety for all purposes.

### FIELD OF INVENTION

Aspects and embodiments disclosed herein are generally directed to speech recognition, and particularly to multilingual speech recognition.

### BACKGROUND

Increased globalization and technological advances have increased the occurrence of multiple languages being blended in conversation. Speech recognition includes the capability to recognize and translate spoken language into text. Conventional speech recognition systems and methods are based on a single language, and are therefore ill-equipped to handle multilingual communication.

### SUMMARY

Aspects and embodiments are directed to a multilingual speech recognition apparatus and method. The systems and methods presented and disclosed herein allow for the capability of recognizing intrasentential speech and to utilize and build upon existing phonetic databases.

One embodiment is directed to a method of multilingual speech recognition that is implemented by a speech recognition device. The method may comprise receiving a multilingual input speech signal, extracting a first phoneme sequence from the multilingual input speech signal, determining a first language likelihood score indicating a likelihood that the first phoneme sequence is identified in a first language dictionary, determining a second language likelihood score indicating a likelihood that the first phoneme sequence is identified in a second language dictionary, generating a query result responsive to the first and second language likelihood scores, and outputting the query result.

In one example, the method further comprises applying a model to phoneme sequences included in the query result to determine a transition probability for the query result. In one example, the model is a Markov model. In another example, the method further comprises identifying features in the multilingual speech input signal that are indicative of a human emotional state, and determining the transition probability based at least in part on the identified features. In one example, the features are at least one of acoustic and lexical features.

In one example, the first language dictionary and the second language dictionary are combined into a single dictionary.

In one example, the method further comprises determining a third language likelihood score indicating a likelihood that the first phoneme sequence is identified in a third language dictionary, and generating the query result responsive to the first, second, and third language likelihood scores.

In one example, the method further comprises applying an algorithm to transcribed phoneme sequences of the query result to transform the query result into a sequence of words.

In one example, the method further comprises compiling transcribed phoneme sequences of the query result into a single document.

In one example, the multilingual input speech signal is configured as an acoustic signal.

In one example, responsive to the query result indicating that the first phoneme sequence is identified in one of the first language dictionary and the second language dictionary the method includes generating the query result as the first phoneme sequences transcribed in the identified language.

In another example, responsive to the query result indicating that the first phoneme sequence is identified in the first language dictionary and the second language dictionary, the method includes performing a query in the first language dictionary and the second language dictionary for a second phoneme sequence and a third phoneme sequence extracted from the multilingual speech input signal to identify a language of the second phoneme sequence and the third phoneme sequence, matching the first phoneme sequence to the identified language of the second phoneme sequence and the third phoneme sequence, and generating the query result as the first phoneme sequence transcribed in the identified language.

In another example, responsive to a result indicating that the first phoneme sequence is not identified in either of the first language dictionary and the second language dictionary, the method includes performing a query for one phoneme of the first phoneme sequence in a phoneme dictionary to identify a language of the one phoneme, concatenating the one phoneme to a phoneme of a second phoneme sequence extracted from the multilingual input speech signal to generate an additional phoneme sequence containing the phoneme of the identified language, performing a query in the first language dictionary and the second language dictionary for the additional phoneme sequence to identify a language of the additional phoneme sequence, and generating the query result as phoneme sequences transcribed in the identified language from the additional phoneme sequence. In one example, the phoneme dictionary includes phonemes of the first language and the second language.

According to another embodiment, a multilingual speech recognition apparatus includes a signal processing unit adapted to receive a multilingual speech signal, a storage device configured to store a first language dictionary and a second language dictionary, an output device, a processor connected to the signal processing unit, the storage device, and the output device, and configured to extract a first phoneme sequence from the multilingual input speech signal received by the signal processing unit, determine a first language likelihood score that indicates a likelihood that the first phoneme sequence is identified in the first language dictionary, determine a second language likelihood score that indicates a likelihood that the first phoneme sequence is identified in the second language dictionary, generate a query result responsive to the first and the second language likelihood scores, and output the query result to the output device.

In one example, the processor is further configured to apply a model to phoneme sequences included in the query result to determine a transition probability for the query result. In another example, the processor is further configured to identify features in the multilingual speech input signal that are indicative of a human emotional state, and determine the transition probability based at least in part on the identified features. In one example, the features are at least one of acoustic and lexical features.

In one example, the storage device is configured to store the first language dictionary and the second language dictionary as a single dictionary.

In one example, the storage device is configured to store a third language dictionary, and the processor is configured to determine a third language likelihood score indicating a likelihood that the first phoneme sequence is identified in the third language dictionary and to generate the query result responsive to the first, second, and third language likelihood scores.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A is a flow diagram of a conventional speech recognition scheme;

FIG. 1B is a flow diagram of a conventional use of emotion detection in speech;

FIG. 1C is a flow diagram of a conventional use of emotion detection in text;

FIG. 2 is a flow diagram of a multilingual speech recognition process in accordance with aspects of the invention;

FIGS. 3A-3C show a flow diagram of a multilingual speech recognition method in accordance with aspects of the invention; and

FIG. 4 is a block diagram of a multilingual speech recognition apparatus in accordance with aspects of the invention.

### DETAILED DESCRIPTION

Multilingual conversations are common, especially outside the English-speaking world. A speaker may inject one or two words from a different language in the middle of a sentence or may start a sentence in one language and switch to a different language mid-sentence for completing the sentence. Speakers who know more than one language may also be more likely to mix languages within a sentence than monolingual speakers, especially in domain-specific conversations (e.g., technical, social). This is particularly true when one of the languages is an uncommon or rare language (“low resource language”), e.g., a dialect with no written literature, a language spoken by a small population, a language with limited vocabulary in the domain of interest, etc. Mixing languages in written documents is less common, but does occur with regular frequency in the technical domain, where an English term for a technical word is often preferred, or in instances where historians quote an original source.

Typical speech recognition schemes assume conversations occur in a single language, and thereby assume intersentential code mixing, meaning one sentence/one language. However, in real life multilingual milieus, speech is intrasentential: words from more than one language, usually two, and sometimes three languages may be used in the same sentence. This disclosure presents a method for intrasentential speech recognition and may be used for both speech (spoken) and text (document) types of input. The disclosed systems and methods are capable of being used with English and uncommon languages and new languages can be added to the system. The disclosed methodology provides the ability to transcribe and translate mixed language speech for multiple languages, including low resource languages, and to use and build upon existing single language databases.

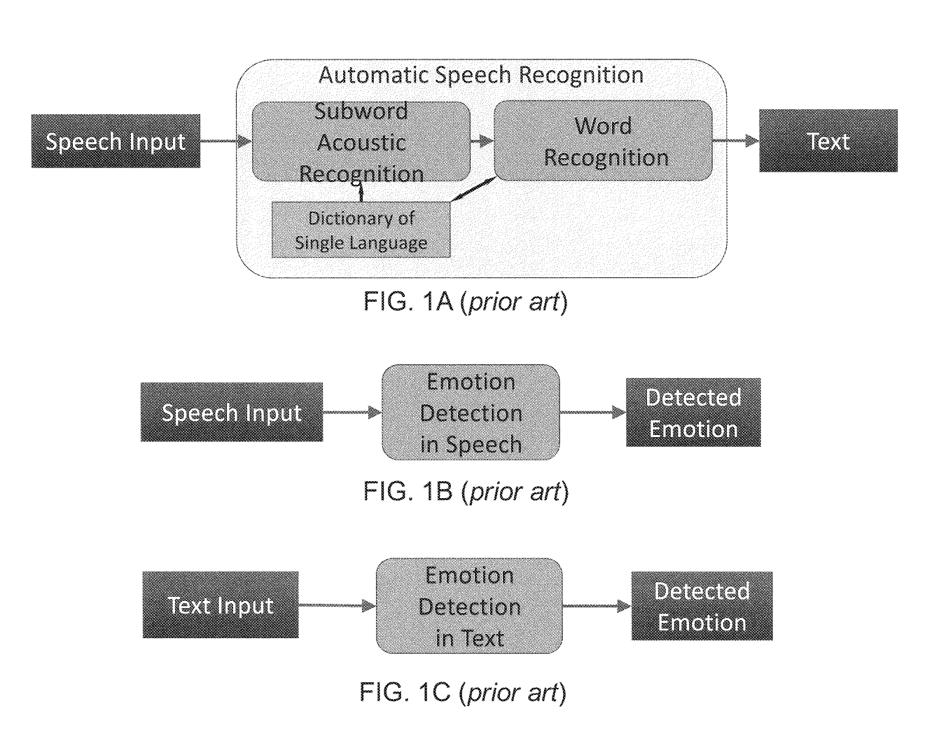

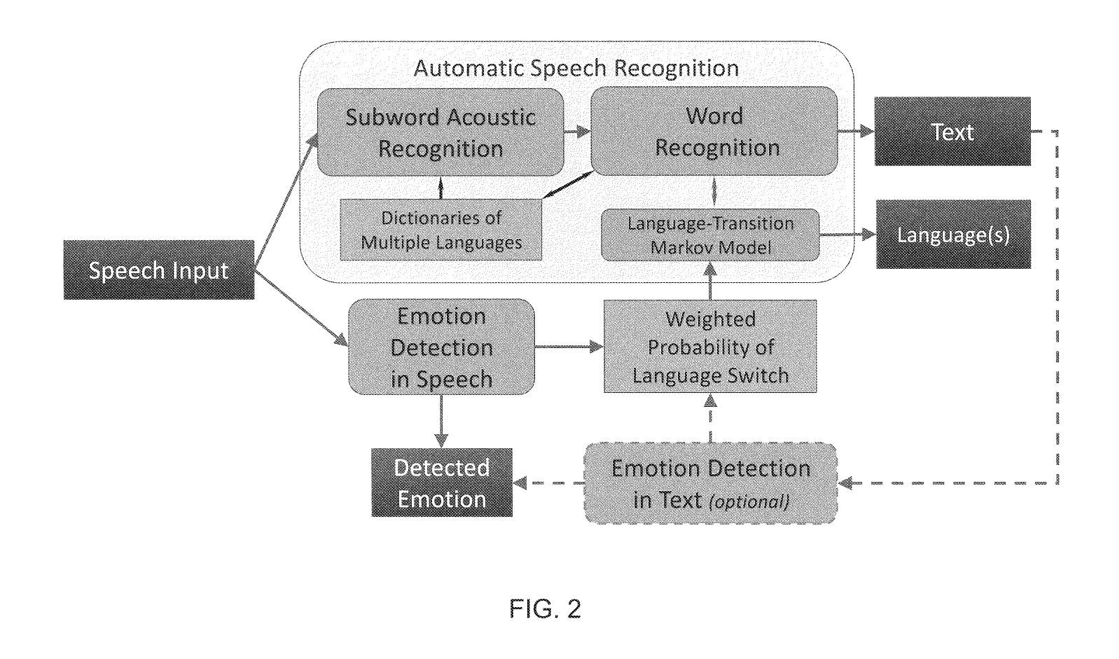

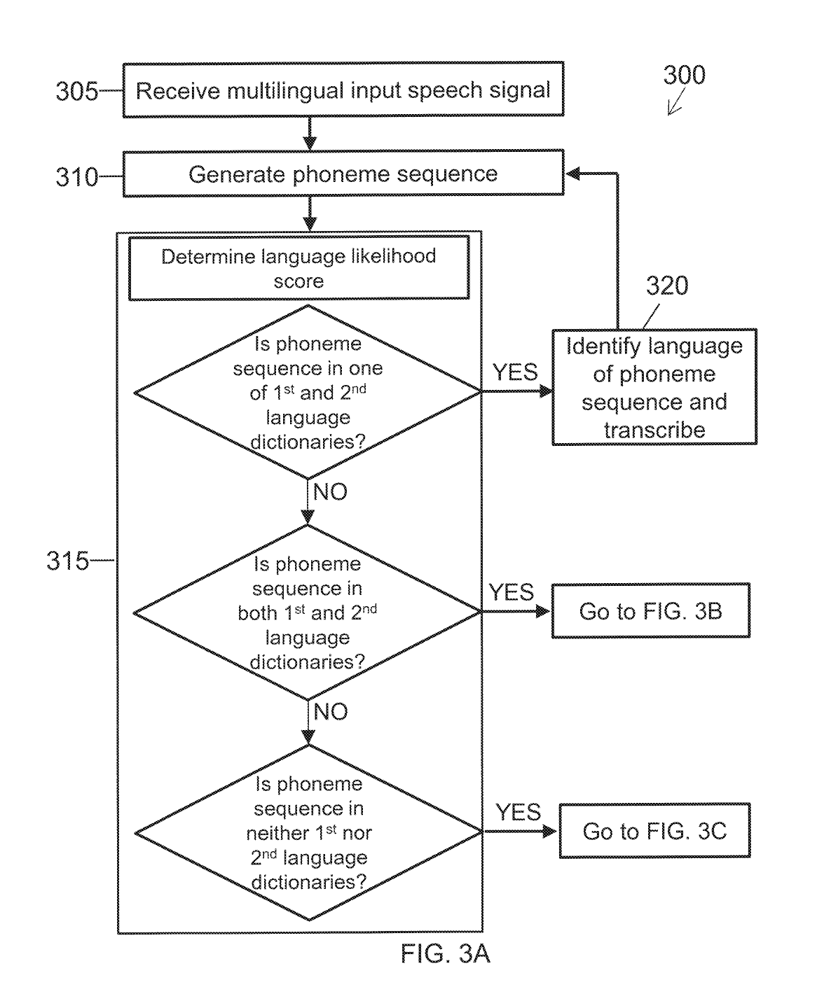

Operation of a typical automatic speech recognition (ASR) engine according to conventional techniques is illustrated in FIG. 1A. Speech input is analyzed by the ASR engine using a dictionary (e.g., database or data structure that includes pronunciation data) of a single language. Commonly borrowed words from other languages may be included in the dictionary, which is the only mechanism by which the system is equipped to handle multilingual speech input. As used herein, the term “multilingual” refers to more than one human language. For instance, the multilingual speech input can include two different languages (e.g., English and Spanish), three different languages, four different languages, or any other multiple number of different languages.

In operation, the ASR system converts the analog speech signal into a series of digital values, and then extracts speech features from the digital values, for example, mel-frequency cepstral coefficients (MFCCs), Relative Spectral Transform—Perceptual Linear Prediction (RASTA-PLP), Linear Predictive Codes (LPC), Perceptual Linear Prediction (PLP), as well as feature vectors, which can be converted into a sequence of phonetically-based units via a hidden Markov model (HMM), artificial neural network (ANN), any machine learning or artificial intelligence algorithm, or any other suitable applicable analytical method. Subsets within the larger sequence are known as phoneme sequences. Phonemes represent individual sounds in words, and represent the smallest units of sound in speech, and distinguish one word from another in a particular language. For example, the word “hello” is represented as two subword units of “HH_AH” and “L_OW,” and each bigram consists of two phonemes. Examples of phoneme sequences include diphones and triphones. A diphone is a sequence of two phonemes, and represents an acoustic unit spanning from the center of one phoneme to the center of a neighboring phoneme. A triphone is a sequence of three phonemes, and represents an acoustic unit spanning three phonemes (such as from the center of one phoneme through the primary phoneme and to the center of the next phoneme).

The single language dictionary of FIG. 1A is a database or data structure of words, phonemes, phoneme sequences, phrases, and sentences that can be used to convert speech data to text data. A search engine (labeled as “Subword Acoustic Recognition” in FIG. 1A searches the dictionary for features, such as a phoneme sequence or other subword unit, that matches the extracted features of the input speech signal and establishes a likelihood of each possible phoneme sequence (or other subword unit) being present at each time frame utilizing, for example, a neural network of phonetic level probabilities. Matched features, i.e., probabilities that exceed a predetermined threshold, are then used by a word matching algorithm (labeled as “Word Recognition” in FIG. 1A) that utilizes a language model that describes words and how they connect to form a sentence. The word matching algorithm examines phoneme sequences within the context of other phoneme sequences around them and then runs the contextual phoneme plot through a model and compares them to known words, phrases, and sentences stored in the dictionary. Based on a statistical outcome, the ASR outputs the result as text.

The model can include a statistical model, for example, the Hidden Markov Model (HMM), artificial neural network (ANN), or HMM can be combined with ANN to form a hybrid approach. Other models are also within the scope of this disclosure. In certain instances, the model can be trained using training speech and predefined timing of text for the speech.

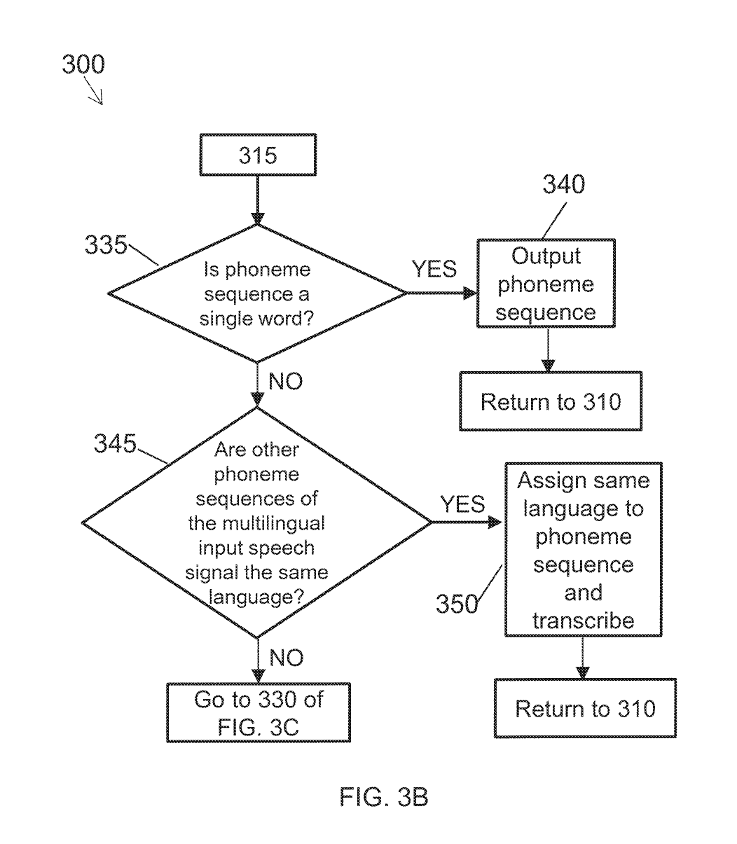

Operation of a speech recognition system according to one embodiment is shown in FIG. 2. One or more aspects of the speech recognition system may function in a similar manner as the process described above in reference to FIG. 1A, but there are several differences. In addition, the speech recognition process described in reference to FIG. 2 improves upon and has advantages over existing speech recognition processes, such as those shown in FIGS. 1A-1C.

According to at least one embodiment, the speech recognition process uses pronunciation dictionaries of multiple languages, instead of a single language dictionary as used in the process shown in FIG. 1A. For example, each language dictionary may include phonemes, phoneme sequences, words, phrases, and sentences in their respective languages. Each language varies in which and how many phonemes it contains. For example, an English-based dictionary could include 36 total phonemes, and 46 triphones, a French-based dictionary could include 37 triphones, and a Japanese dictionary could contain 42 total phonemes. Some languages share overlapping sets of phonemes.

Phones are actual units of speech sound, and refer to any speech sound considered a physical event without regard to its place in the phonology of a language. A phoneme, by comparison, is a set of phones or a set of sound features, and is considered the smallest unit of speech that can be used to make one word different from another word. The processes discussed below in reference to the invention are described in reference to the use of phonemes, but it is to be understood that some embodiments may include mapping phones to phonemes.

As described further below, in some embodiments, the speech recognition process may also include a phoneme dictionary that combines phonemes from multiple different languages into a single database. This “superset” of phonemes may be used to identify phonemes extracted from the speech input signal.

According to one embodiment, the dictionary includes a superset of at least one of the following from multiple different languages: acoustic units, articulatory features, phonemes or other phone-like units, phoneme sequences such as diphones and triphones, demisyllable-like units, syllable-like units, other subword units, words, phrases, and sentences. For example, the dictionary may include phonemes and/or phoneme sequences of both a first language and a second language.

In certain embodiments, the International Phonetic Alphabet (IPA), ARPAbet, or another phonetic alphabet may be used as a basis for defining phonemes, and may be utilized by one or more of the language dictionaries.

The dictionary of the disclosed speech recognition process has a word lexicon that consists of subword units. In some instances, the dictionary may include an appendix that includes pronunciation data that may be accessed and used during the process for purposes of interlingual modification. For example, borrowed words are not always pronounced the same way as in the original language, and different pronunciations of these words could be included in the dictionary. In addition, the pronunciation data may be used in conjunction with a set of pronunciation rules. For example, the letter “p” does not exist in Arabic, and is often pronounced as “b,” and in the English word “perspective,” an Arabic speaker may introduce a vowel to state “bersebective” to break up the sequence of consonants. In another example, the latter “w” as in the English word for “wait” does not exist in German. Pronunciation rules may also be applied to words that are strangely adapted. For example, the root word may not be conjugated according to the normal grammar rules for that language. These types of exceptions and rules may be applied for purposes of processing a phoneme sequence or other subword acoustic unit.

According to some embodiments, the dictionary may incorporate directly or as an appendix, data pertaining to a dialect of a language that may be accessed and used during the speech recognition process. According to other embodiments, the dialect data may be included as a separate dictionary from other forms of the language.

One or more of the dictionaries described above can be trained or otherwise updated to include new data, including new words, phrases, sentences, pronunciation data, etc. In addition, new dictionaries may be created for new languages, or for creating new combinations of data. For example, a dictionary can be created that includes subword (e.g., phoneme sequences such as triphones and diphones, phonemes, and/or words) dictionaries for pairs of languages. In conversations with intrasentential code switching, it is most common for two languages to be used, and less common is for three languages to be used. A dictionary based on a pairing of languages may therefore provide additional efficiencies over using two separate dictionaries. According to another embodiment, a dictionary can be created or otherwise utilized that includes three languages, which may also provide additional efficiencies over using three separate dictionaries. According to other embodiments, a dictionary can be created using multiple languages, including four or more languages.

Returning to FIG. 2, the process includes identifying and extracting phoneme sequences from the input speech signal as described above, but instead of searching a single language dictionary, dictionaries of multiple languages, or a dictionary that combines multiple languages, is utilized by the search engine and the word matching algorithm. For example, a probability, also referred to herein a language likelihood score, can be determined (using, for example HMM and/or ANN) that indicates the likelihood of the phoneme sequence (or other subword unit) being present in each language dictionary, or in a mixed language dictionary, depending on the specific approach used. In some embodiments, a combined language dictionary of two (or more) different languages can be used in a later portion of the process based on previous language likelihood scores obtained in a previous portion of the process. Other components of the process are described below, and at the end of the process, words transcribed from their respective language can be output as text that is multilingual.

According to at least one embodiment, and as shown in FIG. 2, in parallel to the subword unit recognition, the speech recognition process also includes the capability to track an estimated language for words using a model for determining probabilities for continuing with the estimated language or to transition between languages. The example shown in FIG. 2 uses a Markov model for determining the weighted probability or transition probability. For instance, in an example speech input that includes two languages A and B, where language A is dominating, but key words are mentioned in language B, the four probabilities output by the Markov model would include the probability of continuing from language A to language A (pAA), the highest probability, and the probabilities of switching from language A to B (pAB), continuing from language B to B (pBB), and switching from language B to A (pBA), the lowest probability. If a running estimate is made of identifying the current language, such as with a Markov model, then the model weighs the probabilities of occurrence of each phoneme (or other subword acoustic unit used) as per the net probability of its occurrence in the expected language. If there is no running estimate of the current language, then the weighted probabilities of the expected language are merged. In some embodiments, the process can be iterated multiple times, sequentially or in parallel, to determine different phoneme probabilities and use the results with the highest or net best language likelihood score.

Returning to FIG. 2, operation of the speech recognition process also includes the capacity to account for emotion detection. The process may be configured to identify features in the multilingual speech input signal that are indicative of a human emotional state. According to one embodiment, different categories can be used to indicate a human emotional state: anger, disgust, fear, happiness, sadness, and surprise. However, these emotion states are not limiting, and other states are also within the scope of this disclosure. Mixing languages within a sentence occurs more often in stressful situations, and is often a function of the emotional state of the conversation. As discussed further below, emotion detected in the speech input can also be used for determining the weighting probabilities or language likelihood scores associated with switching languages.

FIG. 1B shows the treatment of emotion detection in speech according to conventional techniques. One or more features, including acoustic features, extracted from the speech input signal can be used to detect emotion. These features refer to a statistic of a speech signal parameter that is calculated from a speech segment or fragment, and non-limiting examples include pitch, amplitude of the speech signal, frequency spectrum, formants and temporal features, such as duration, and pausing. One or more algorithms, such as statistical analysis and a neural network classifier, or any other applicable analysis, can be applied to the features to determine the emotional state of the speaker. The detected emotional state is output as a separate entity from transcribed speech.

FIG. 1C shows the treatment of emotion detection in text according to the conventional techniques, and works in some respects in a similar manner to the speech input process described above in reference to FIG. 1B, but uses a slightly different approach. The text input is analyzed by a sentiment analyzer that extracts emotional cues from words and/or sentences (i.e., lexical features) included in the text and provides an initial label for these components that can then be used for further analysis. Statistic-based, rule-based, and hybrid approaches, or other methods known in the art can then be applied to the labeled components to determine the speaker's emotional state. As with the emotion detection in speech, emotion detection in text according to conventional techniques is considered a separate consideration from the speech transcription process.

In contrast to the emotion detection scheme used by conventional speech recognition systems that output a separate detected emotional state, at least one embodiment of the present invention includes the use of emotion detection in the speech recognition process itself. As shown in FIG. 2, speech input or text can be analyzed in a similar manner as described above in reference to FIGS. 1B and 1C. In addition, other features that may be extracted from the speech input signal according to the present invention include lexical features, such as word choice. According to at least one embodiment, extracted features or components associated with emotion can be added as a separate weight in determining the probabilities of switching languages, i.e., transition probability. This gives the disclosed process the ability to account for a stressed speaker, who is more likely to switch languages, by adding a mechanism for influencing the transition probabilities. In addition, FIG. 2 indicates that the speech recognition process can also output a separate detected emotional state, as is done in the emotional detection schemes of FIGS. 1B and 1C using similar processes.

As indicated in FIG. 2, the disclosed speech recognition process employs the use of specific mathematical rules for generating transcribed text that is a technological improvement over existing speech recognition processes, including the processes shown in FIGS. 1A-1C.

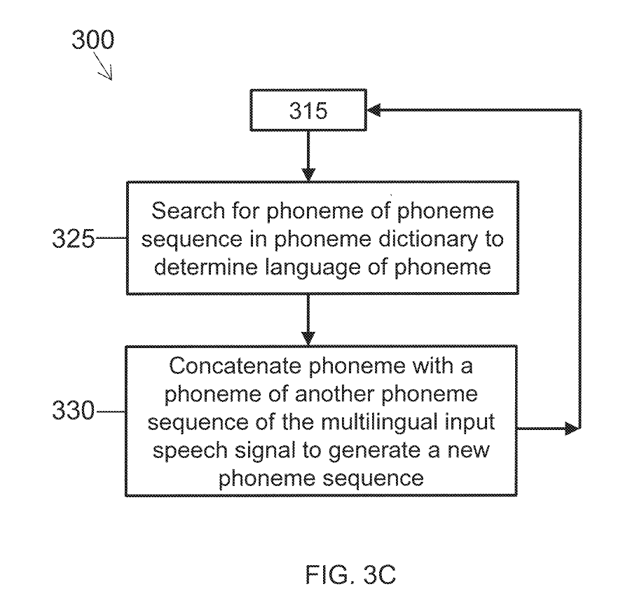

Aspects of the multilingual speech recognition scheme shown in FIG. 2 can be implemented in a process 300 described below in reference to FIGS. 3A-3C. The process is described in reference to two different languages, i.e., first and second language dictionaries, but it is to be appreciated that more than two languages may be applied to the process and using three or more languages is also within the scope of this disclosure.

A multilingual speech input signal is first received at 305. In some embodiments, speech input may be an audio file, and speech signals may be extracted from the audio data. According to some embodiments, the speech input signal may be configured as an acoustic signal.

A phoneme sequence is extracted from the speech input signal at 310. According to some embodiments, the phoneme sequence is a triphone, and in other embodiments, the phoneme sequence is a diphone. The phoneme sequence can be extracted from the speech input signal using known techniques, such as those described above. The speech input signal may include several phoneme sequences consecutively strung together, and the process is designed to analyze one phoneme sequence at a time until all the phoneme sequences of the speech input have been analyzed. At 315, a search or query is performed in each of the first and second language dictionaries, and the process includes determining a probability that the phoneme sequence is in the respective language dictionary, i.e., a language likelihood score. Different actions are taken depending on these probabilities and output (also referred to herein as a query result), as described below, depending on whether the respective language likelihood scores are above or below a predetermined threshold.

If the respective language likelihood scores reflect that the phoneme sequence is found in one of the first and second language dictionaries (i.e., the language likelihood score is above the predetermined threshold for one of the dictionaries), then at 320 the matching or mapped language is identified as the language of the phoneme sequence and the phoneme sequence is transcribed, i.e., output in written form. The process then returns to 310, where another phoneme sequence extracted from the speech input signal is analyzed. In some instances, the process starts with the first phoneme sequence in the speech signal, and moves to the second and third phoneme sequences in a sequential manner.

If the respective language likelihood scores at 315 reflect that the phoneme sequence is found in both the first and the second language dictionary (i.e., the respective language likelihood scores are above the predetermined threshold), then the process moves to FIG. 3B, where a determination is made at 335 (which can include determining a probability) as to whether the phoneme sequence is a single word. This can be accomplished, for example, by performing a search of the dictionary in conjunction with weighted probabilities. If the probability indicates that the phoneme sequence is a single word (YES at 335), then it is assumed that the phoneme sequence is in both languages, or is a proper noun that is pronounced the same in both languages. The phoneme sequence is then output “as-is” at 340 and the process returns to 310 to analyze another phoneme sequence. If the phoneme sequence is not a single word (NO at 335), then at 345 other phoneme sequences extracted from the speech input signal are analyzed to determine if they are of the same language, which may include determining a language likelihood score. For instance, two other phoneme sequences, such as triphones, may be searched in the dictionaries of the respective languages, and if each of the two phoneme sequences is matched to the same language, e.g., French, then that same language is assigned or otherwise identified as the language of the phoneme sequence. In some instances, the two phoneme sequences may be previous and subsequent phoneme sequences to the main phoneme sequence being analyzed. Once the language is assigned at 350, the phoneme sequence is then transcribed and the process returns to 310 to analyze another phoneme sequence of the input signal. If each of the two phoneme sequences are not matched to the same language, then the process moves to 330 of FIG. 3C, which is described below.

If the respective language likelihood scores at 315 reflect that the phoneme sequence is in neither the first language dictionary nor the second language dictionary (i.e., the respective language likelihood scores are below the predetermined threshold), then the process moves to FIG. 3C, where at 325 a phoneme of the phoneme sequence is searched within a dictionary that contains phonemes of multiple languages. For example, if the phoneme sequence is a triphone, the middle phoneme can be used to search the phoneme dictionary to find a language that matches the phoneme (e.g., by determining a language likelihood score that is above a predetermined threshold). Once the language of the phoneme is identified, then at 330 the phoneme is concatenated with a phoneme of another phoneme sequence extracted from the speech input to generate a new phoneme sequence. For example, if a middle phoneme of a triphone is searched in 325, then the middle phoneme may be concatenated together with either (1) the first phoneme of the triphone and the last phoneme of a preceding triphone (of the speech input signal), or (2) the last (third) phoneme of the triphone and the first phoneme of a subsequent triphone. In the case of phoneme sequences that are triphones, then the phoneme of the phoneme sequence can thus also be concatenated with a phoneme of the original triphone. In the case of diphones, the phoneme would be concatenated with only a phoneme of another diphone in the speech input signal. Once the new phoneme sequence is formed at 330, the process returns to 315. Since the language of one phoneme of the phoneme sequence was identified at 325, the query performed at 315 can use the dictionary associated with the identified language as one of the first or second dictionaries that is searched.

As noted above, process 300 can be re-iterated until each phoneme sequence of the original speech input signal has been transcribed. The transcribed phoneme sequences (orthography) can then be assembled into a document, and an algorithm, such as a hierarchy of HMMs as described above, or other algorithms known in the art can be applied to transform the phoneme sequences into words.

Process 300 depicts one particular sequence of acts in a particular embodiment. The acts included in this process may be performed by, or using, one or more computer systems specially configured as discussed herein. Some acts may be optional and, as such, may be omitted in accordance with one or more embodiments. Additionally, the order of acts may be altered, or other acts can be added, without departing from the scope of the embodiments described herein. Furthermore, as described herein, in at least one embodiment, the acts may be performed on particular, specially configured machines, namely a speech recognition apparatus configured according to the examples and embodiments disclosed herein.

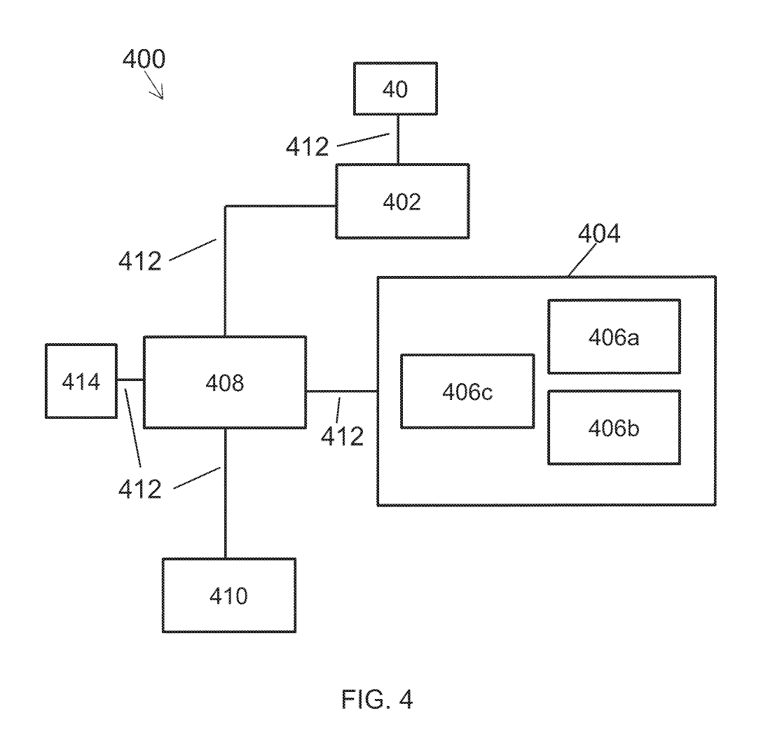

One non-limiting example of a multilingual speech recognition apparatus or device for executing or otherwise implementing the multilingual speech processes described herein is shown generally at 400 in FIG. 4. Apparatus 400 may include or be part of a personal computer, workstation, video or audio recording or playback device, cellular device, or any other computerized device, and may include any device capable of executing a series of instructions to save, store, process, edit, transcribe, display, project, receive, transfer, or otherwise use or manipulate data, for example, speech input data. According to one embodiment, the apparatus 400 may also include the capability of recording speech input data. The apparatus 400 includes a signal processor 402, a storage device 404, a processor 408, and an output device 410.

The signal processor 402, also referred to as a signal processing unit, may be configured to receive a multilingual speech input signal 40. The input signal 40 may be transferred through a network 412 (described below) wirelessly or through a microphone of an input device 414 (described below), such as a user interface. The signal processor 402 may be configured to detect voice activity as a speech input signal and to remove background noise from the input signal. In some instances, the signal processor 402 may be configured to extract feature data from the speech input signal, such as amplitude, frequency, etc. According to one embodiment, the signal processor 402 may be configured to perform analog to digital conversion of the input speech signal 40.

Apparatus 400 may include a processor 408, such as a central processing unit (CPU), a digital signal processor (DSP), a microprocessor, a controller, a chip, a microchip, a field-programmable gate array (FPGA), an application-specific integrated circuit (ASIC), or any other integrated circuit (IC), or any other suitable multi-purpose or specific processor or controllers. Processor 408 may include more than one processor and/or more than one processing core. The processor 408 may perform operations according to embodiments of the invention by executing, for example, code or instructions stored in storage device 404. The code or instructions may be configured as software programs and/or modules stored in memory of the storage device 404 or other storage device.

Apparatus 400 may include one or more memory or storage devices 404 for storing data associated with speech recognition processes described herein. For instance, the storage device 404 may store one or more language dictionaries 406, including a first language dictionary 406a, a second language dictionary 406b, and a multi-language phoneme dictionary 406c. Other dictionaries as described herein may also be included in storage device 404. Each dictionary may include a database or data structure of one or more of phoneme sequences, phonemes, words, phrases, sentences, as well as word recognition, pronunciation, grammar, and/or linguistic rules. In some instances, the storage device 404 may also store audio files of audio data taken as speech input. The storage device 404 may be configured to include, for example, random access memory (RAM), dynamic RAM (DRAM), flash memory, cache memory, volatile memory, non-volatile memory, one or more external drivers, or other suitable memory units or storage units to store data generated by, input into, or output from apparatus 400. The processor 408 is configured to control the transfer of data into and out of the storage device 404.

Non-limiting examples of the output device 410 include a monitor, projector, screen, printer, speakers, or display for displaying transcribed speech input data or query results (e.g., transcribed phonemes, phoneme sequences, words, etc.) on a user interface according to a sequence of instructions executed by the processor 408. The output device 410 may display query results on a user interface, and in some embodiments, a user may select (e.g., via input device 414 described below) one or more of the query results, for example, to verify a result or to select a correct result from among a plurality of results.

Components of the apparatus 400 may be connected to one another via an interconnection mechanism or network 412, which may be wired or wireless, and functions to enable communications (e.g., data, instructions) to be exchanged between different components or within a component. The interconnection mechanism 412 may include one or more buses (e.g., between components that are integrated within a same device) and/or a network (e.g., between components that reside on separate devices).

Apparatus 400 may also include an input device 414, such as a user interface for a user or device to interface with the apparatus 400. For instance, additional training data can be added to one or more of the dictionaries 406 stored in the storage device 408. Non-limiting examples of input devices 414 include a keyboard, mouse, speaker, microphone, and touch screens.

According to various aspects, embodiments of the invention may include, without limitation, methods, systems, and sets of computer-executable instructions embodied on one or more computer-readable media. Computer-readable media include both volatile and nonvolatile media, removable and non-removable media, and media readable by a database and various other network devices. By way of example and not limitation, computer-readable storage media comprise media implemented in any method or technology for storing information. Examples of stored information include computer-useable instructions, data structures, program modules, and other data representations. Media examples include, but are not limited to information-delivery media, random access memory (RAM), read-only memory (ROM), electrically erasable programmable read-only memory (EEPROM), flash memory or other memory technology, compact-disc read-only memory (CD-ROM), digital versatile discs (DVD), Blu-ray disc, holographic media or other optical disc storage, magnetic cassettes, magnetic tape, magnetic disk storage, and other magnetic storage devices. These examples of media can be configured to store data momentarily, temporarily, or permanently. The computer-readable media include cooperating or interconnected computer-readable media, which exist exclusively on a processing system or distributed among multiple interconnected processing systems that may be local to, or remote from, the processing system.

In accordance with various aspects, embodiments of the invention may be described in the general context of computer code or machine-useable instructions, including computer-executable instructions such as program modules, being executed by a computing system, or other machine or machines. Generally, program modules including routines, programs, objects, components, data structures, and the like refer to code that perform particular tasks or implement particular data types. Embodiments described herein may be implemented using a variety of system configurations, including handheld devices, consumer electronics, specialty computing devices, etc. Embodiments described herein may also be implemented in distributed computing environments, using remote-processing devices that are linked through a communications network, such as the Internet.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A method of multilingual speech recognition implemented by a speech recognition device, comprising:
receiving a multilingual input speech signal;
extracting a first phoneme sequence from the multilingual input speech signal;
determining a first language likelihood score indicating a likelihood that the first phoneme sequence is identified in a first language dictionary;
determining a second language likelihood score indicating a likelihood that the first phoneme sequence is identified in a second language dictionary;
generating a query result responsive to the first and second language likelihood scores; and
outputting the query result.

2. The method of claim 1, further comprising applying a model to phoneme sequences included in the query result to determine a transition probability for the query result.

3. The method of claim 2, wherein the model is a Markov model.

4. The method of claim 2, further comprising:
identifying features in the multilingual speech input signal that are indicative of a human emotional state; and
determining the transition probability based at least in part on the identified features.

5. The method of claim 4, wherein the features are at least one of acoustic and lexical features.

6. The method of claim 1, wherein the first language dictionary and the second language dictionary are combined into a single dictionary.

7. The method of claim 1, further comprising determining a third language likelihood score indicating a likelihood that the first phoneme sequence is identified in a third language dictionary, and generating the query result responsive to the first, second, and third language likelihood scores.

8. The method of claim 1, further comprising applying an algorithm to transcribed phoneme sequences of the query result to transform the query result into a sequence of words.

9. The method of claim 1, further comprising compiling transcribed phoneme sequences of the query result into a single document.

10. The method of claim 1, wherein the multilingual input speech signal is configured as an acoustic signal.

11. The method of claim 1, wherein responsive to the query result indicating that the first phoneme sequence is identified in one of the first language dictionary and the second language dictionary:
generating the query result as the first phoneme sequences transcribed in the identified language.

12. The method of claim 1, wherein responsive to the query result indicating that the first phoneme sequence is identified in the first language dictionary and the second language dictionary:
performing a query in the first language dictionary and the second language dictionary for a second phoneme sequence and a third phoneme sequence extracted from the multilingual speech input signal to identify a language of the second phoneme sequence and the third phoneme sequence;
matching the first phoneme sequence to the identified language of the second phoneme sequence and the third phoneme sequence; and
generating the query result as the first phoneme sequence transcribed in the identified language.

13. The method of claim 1, wherein responsive to a result indicating that the first phoneme sequence is not identified in either of the first language dictionary and the second language dictionary:
performing a query for one phoneme of the first phoneme sequence in a phoneme dictionary to identify a language of the one phoneme;
concatenating the one phoneme to a phoneme of a second phoneme sequence extracted from the multilingual input speech signal to generate an additional phoneme sequence containing the phoneme of the identified language;
performing a query in the first language dictionary and the second language dictionary for the additional phoneme sequence to identify a language of the additional phoneme sequence; and
generating the query result as phoneme sequences transcribed in the identified language from the additional phoneme sequence.

14. The method of claim 13, wherein the phoneme dictionary includes phonemes of the first language and the second language.

15. A multilingual speech recognition apparatus, comprising:
a signal processing unit adapted to receive a multilingual speech signal;
a storage device configured to store a first language dictionary and a second language dictionary;
an output device;
a processor connected to the signal processing unit, the storage device, and the output device, configured to:
extract a first phoneme sequence from the multilingual input speech signal received by the signal processing unit;
determine a first language likelihood score that indicates a likelihood that the first phoneme sequence is identified in the first language dictionary;
determine a second language likelihood score that indicates a likelihood that the first phoneme sequence is identified in the second language dictionary;
generate a query result responsive to the first and the second language likelihood scores; and
output the query result to the output device.

16. The apparatus of claim 15, wherein the processor is further configured to apply a model to phoneme sequences included in the query result to determine a transition probability for the query result.

17. The apparatus of claim 16, wherein the processor is further configured to:
identify features in the multilingual speech input signal that are indicative of a human emotional state; and
determine the transition probability based at least in part on the identified features.

18. The apparatus of claim 17, wherein the features are at least one of acoustic and lexical features.

19. The apparatus of claim 15, wherein storage device is configured to store the first language dictionary and the second language dictionary as a single dictionary.

20. The apparatus of claim 15, wherein the storage device is configured to store a third language dictionary, and the processor is configured to determine a third language likelihood score indicating a likelihood that the first phoneme sequence is identified in the third language dictionary and to generate the query result responsive to the first, second, and third language likelihood scores.
